(19) United States
(12) Patent Application Publication
(10) Pub. No.: US 2016/0342036 A1
(43) Pub. Date: Nov. 24, 2016

(54) UV2A PIXEL STRUCTURE

(71) Applicant: SHENZHEN CHINA STAR OPTOELECTRONICS TECHNOLGY CO. LTD., Shenzhen, Guangdong (CN)

(72) Inventors: Chenghung CHEN, Shenzhen, Guangdong (CN); Xiaohui YAO, Shenzhen, Guangdong (CN)

(73) Assignee: Shenzhen China Star Optoelectronics Technology Co. Ltd., Shenzhen, Guangdong (CN)

(21) Appl. No.: 14/428,640

(22) PCT Filed: Feb. 8, 2015
(86) PCT No.: PCT/CN2015/072466

§ 371 Date: Mar. 16, 2015

(30) Foreign Application Priority Data
Nov. 20, 2014 (CN) 201410669374.2

(51) Int. Cl. G02F 1/1343; G02F 1/1337

(52) U.S. Cl. CPC G02F 1/134309; G02F 1/133753; G02F 1/133788; G02F 2201/123; G02F 2201/52; G02F 2001/134345; G02F 2001/133757; G02F 2001/133742

(57) ABSTRACT

The present invention provides a UV²A pixel structure, comprising a plurality of pixel units (1) arranged in an array, and each pixel unit (1) comprises three parallel arranged sub pixels, which sequentially are a red sub pixel (11), a green sub pixel (12) and a blue sub pixel (13), and the red sub pixel (11), the green sub pixel (12) and the blue sub pixel (13) are respectively constructed by one single alignment sub area or two alignment sub areas which alignment directions are orthogonal; in two adjacent sub pixels, alignment directions of corresponding alignment sub areas are orthogonal, or in two adjacent pixel units (1), alignment directions of alignment sub areas of corresponding sub pixels are orthogonal. According to the UV²A pixel structure of the present invention, the dark fringes in each sub pixel can be diminished to raise the light transmittance and to lower the process difficulty of the liquid crystal panel for promoting the production efficiency and saving the manufacture cost.

### FIELD OF THE INVENTION

The present invention relates to a display technology field, and more particularly to a UV²A pixel structure.

### BACKGROUND OF THE INVENTION

The LCD (Liquid Crystal Display) possesses many advantages of being ultra thin, power saved and radiation free. It has been widely utilized in, such as LCD TVs, mobile phones, PDAs, digital cameras, laptop screens or notebook screens. Most of LCDs are backlight type LCDs, comprising a shell, a LCD panel located in the shell and a backlight module located in the shell. Particularly, the LCD panel mainly comprises a CF (Color Filter), a TFT Array Substrate (Thin Film Transistor Array Substrate) and a Liquid Crystal Layer filled between the two substrates. The working principle is that the light of backlight module is reflected to generate images by applying driving voltages to the two glass substrates for controlling the rotations of the liquid crystal molecules.

For the TFT-LCD panels in the present main market, three types can be illustrated, which respectively are Twisted Nematic/Super Twisted Nematic (TN/STN), In-Plane Switching (IPS) and Vertical Alignment (VA). In the manufacture process of the liquid crystal display panel, the alignment is an important process to realize that the liquid crystal molecules to be aligned according to the specific direction and angle by the alignment process. The traditional alignment process utilizes the Rubbing method, which the alignment can only in one horizontal direction and has been widely employed in TN type, IPS type liquid crystal panels. However, the VA type liquid crystal panel requires expanding its view angle and the sub pixels are divided into many areas. The alignment direction in each area is different. Therefore, the rubbing method cannot be utilized.

The ultraviolet induced multi-domain vertical alignment (UV²A) is one kind of light alignment technology of the VA type liquid crystal panel. As shown in FIG. 1, the UV²A utilizes ultraviolet light to obliquely shine on the Polyimide (PI) film 10 with a certain angle to form alignment micro structures 20 having a certain oblique angle on the surface of the Polyimide film 10. Accordingly, the liquid crystal molecules 30 have a pre-tilted angle on the surface of the Polyimide film 10. After the UV²A alignment, the angle of the micro structures 20 formed on the surface of the Polyimide film 10 and the oblique angle of the ultraviolet light are coincident and the alignment precision is higher

With the development of the liquid crystal display technology, the high resolution liquid display panel (such as 4K2K, 8K4K) has become popular product at present. However, the aperture ratio of the high resolution liquid display panel is lower. Therefore, the transmitting light percentage (T%) of the incident light and the light transmittance are lower. As concerning the view angle issue of the VA type liquid crystal display, in the present UV²A pixel structure as shown in FIG. 2, the red sub pixel 101, the green sub pixel 102 and the blue sub pixel 103 in each pixel unit 100 are respectively divided into four alignment sub areas having the same dimension. Meanwhile, the alignment directions of two adjacent alignment sub areas in one sub pixel are orthogonal. A cross dark fringe will form at the edges among the four alignment sub areas of each sub pixel and affect the light transmittance.

### SUMMARY OF THE INVENTION

An objective of the present invention is to provide a UV²A pixel structure, which can diminish the dark fringes in each sub pixel to raise the light transmittance and to lower the process difficulty of the liquid crystal panel for promoting the production efficiency and saving the manufacture cost.

For realizing the aforesaid objective, the present invention provides a UV²A pixel structure, comprising a plurality of pixel units arranged in an array, wherein each pixel unit comprises three parallel arranged sub pixels, which sequentially are a red sub pixel, a green sub pixel and a blue sub pixel, and the red sub pixel, the green sub pixel and the blue sub pixel are respectively constructed by one single alignment sub area or two alignment sub areas which alignment directions are orthogonal; in two adjacent sub pixels, alignment directions of corresponding alignment sub areas are orthogonal, or in two adjacent pixel units, alignment directions of alignment sub areas of corresponding sub pixels are orthogonal.

The red sub pixel, the green sub pixel and the blue sub pixel are respectively constructed by two left, right alignment sub areas which alignment directions are orthogonal, and in two upper, lower adjacent pixel units, alignment directions of alignment sub areas of corresponding sub pixels are orthogonal.

The red sub pixel, the green sub pixel and the blue sub pixel are respectively constructed by two upper, lower alignment sub areas which alignment directions are orthogonal, and in two left, right adjacent pixel units, alignment directions of alignment sub areas of corresponding sub pixels are orthogonal.

The red sub pixel, the green sub pixel and the blue sub pixel are respectively constructed by two upper, lower alignment sub areas which alignment directions are orthogonal, and in two left, right adjacent sub pixels, alignment directions of corresponding alignment sub areas are orthogonal.

The red sub pixel, the green sub pixel and the blue sub pixel are respectively constructed by one single alignment sub area, and in two upper, lower adjacent sub pixels and two left, right adjacent sub pixels, alignment directions of alignment sub areas are orthogonal.

The red sub pixel, the green sub pixel and the blue sub pixel are respectively constructed by one single alignment sub area, and in two upper, lower adjacent pixel units and two left, right adjacent pixel units, alignment directions of alignment sub areas of corresponding sub pixels are orthogonal.

In one sub pixel, dimensions of the alignment sub areas which alignment directions are orthogonal are equal.

Included angles between the alignment directions and the horizontal direction are 45° or −45°.

The benefits of the present invention are: the present invention provides a UV²A pixel structure, and respective sub pixels in each pixel unit are constructed by one single alignment sub area or two alignment sub areas, which can diminish the dark fringes at edge of the alignment sub areas in each sub pixel. By setting the alignment directions of the corresponding alignment sub areas in two adjacent sub pixels to be orthogonal, or the alignment directions of the alignment sub areas of the corresponding sub pixels in two adjacent pixel units to be orthogonal for the view angle compensation to raise the light transmittance and to lower the process difficulty for promoting the production efficiency and saving the manufacture cost.

### BRIEF DESCRIPTION OF THE DRAWINGS

The technical solution and the beneficial effects of the present invention are best understood from the following detailed description with reference to the accompanying figures and embodiments.

In drawings,

FIG. 1 is a diagram of a UV²A alignment method;

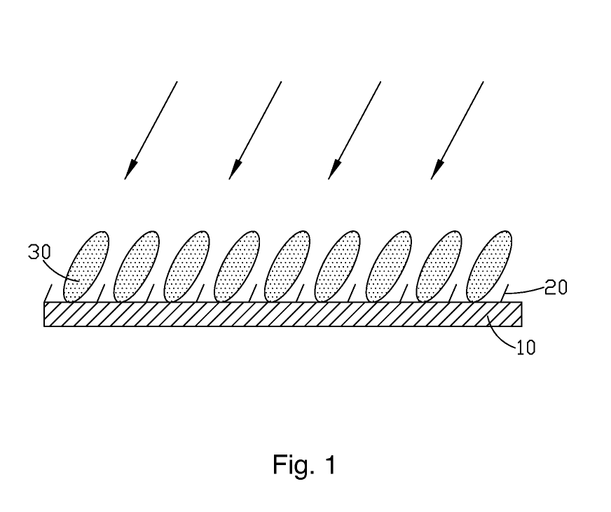

FIG. 2 is a diagram of a UV²A pixel structure according to prior art;

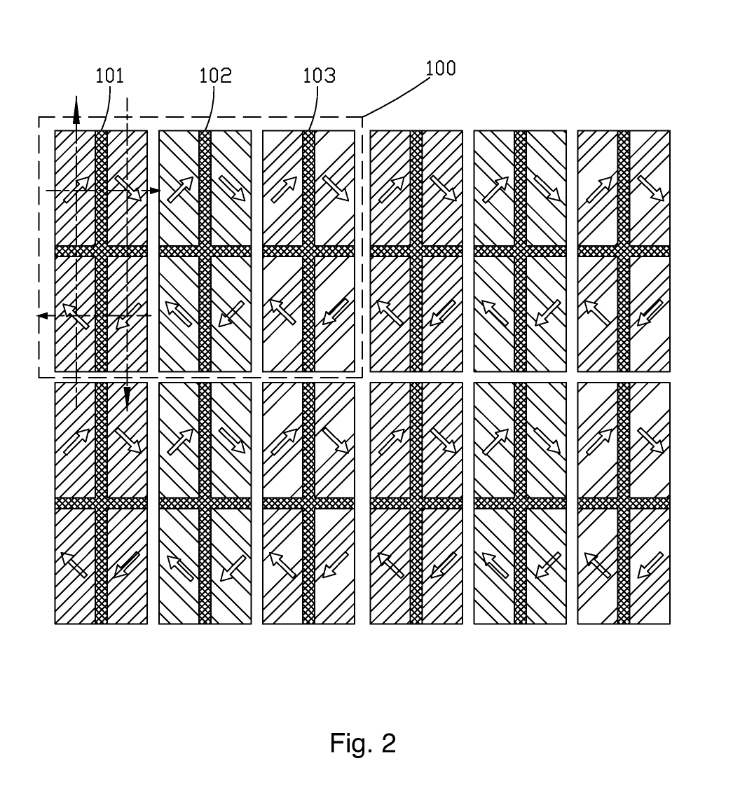

FIG. 3 is a diagram of a UV²A pixel structure according to the first embodiment of the present invention;

FIG. 4 is a diagram of a UV²A pixel structure according to the second embodiment of the present invention;

FIG. 5 is a diagram of a UV²A pixel structure according to the third embodiment of the present invention;

FIG. 6 is a diagram of a UV²A pixel structure according to the fourth embodiment of the present invention;

FIG. 7 is a diagram of a UV²A pixel structure according to the fifth embodiment of the present invention.

### DETAILED DESCRIPTION OF PREFERRED EMBODIMENTS

For better explaining the technical solution and the effect of the present invention, the present invention will be further described in detail with the accompanying drawings and the specific embodiments.

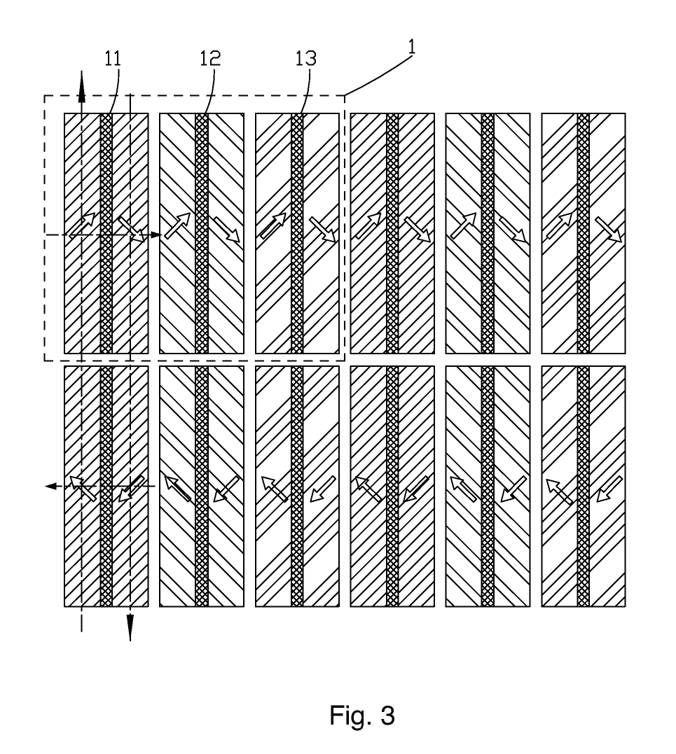

The present invention provides a UV²A pixel structure. FIG. 3 is a diagram of a UV²A pixel structure according to the first embodiment of the present invention. The UV²A pixel structure comprises a plurality of pixel units 1 arranged in an array, and each pixel unit comprises three parallel-arranged sub pixels, which sequentially are a red sub pixel 11, a green sub pixel 12 and a blue sub pixel 13. The red sub pixel 11, the green sub pixel 12 and the blue sub pixel 13 are respectively constructed by two left, right alignment sub areas which alignment directions are orthogonal. The dimensions of the two left, right alignment sub areas which alignment directions are orthogonal are equal. The included angle of the alignment direction of one alignment sub area and the horizontal direction is 45°. The included angle of the alignment direction of the other alignment sub area and the horizontal direction is −45°. In two upper, lower adjacent pixel units 1, the alignment directions of the alignment sub areas of the corresponding sub pixels are orthogonal. For instance, in two upper, lower adjacent pixel units 1, the alignment direction of alignment sub area at the left side of the red sub pixel 11 on the top and the alignment direction of alignment sub area at the left side of the red sub pixel 11 on the bottom are orthogonal.

Compared with the UV²A pixel structure, which each sub pixel is constructed by four alignment sub areas according to prior art, the amount of the alignment sub areas in each sub pixel in the first embodiment is decreased down to two. The dark fringes at the edge of the two corresponding alignment sub areas can be decreased. Accordingly, the light transmittance can be raised and the process difficulty can be lowered for promoting the production efficiency and saving the manufacture cost. By setting the alignment directions of the two alignment sub areas of the corresponding sub pixels in the two upper, lower pixel unit 1 to be orthogonal, the top, bottom view angles can be compensated to ensure the display effect.

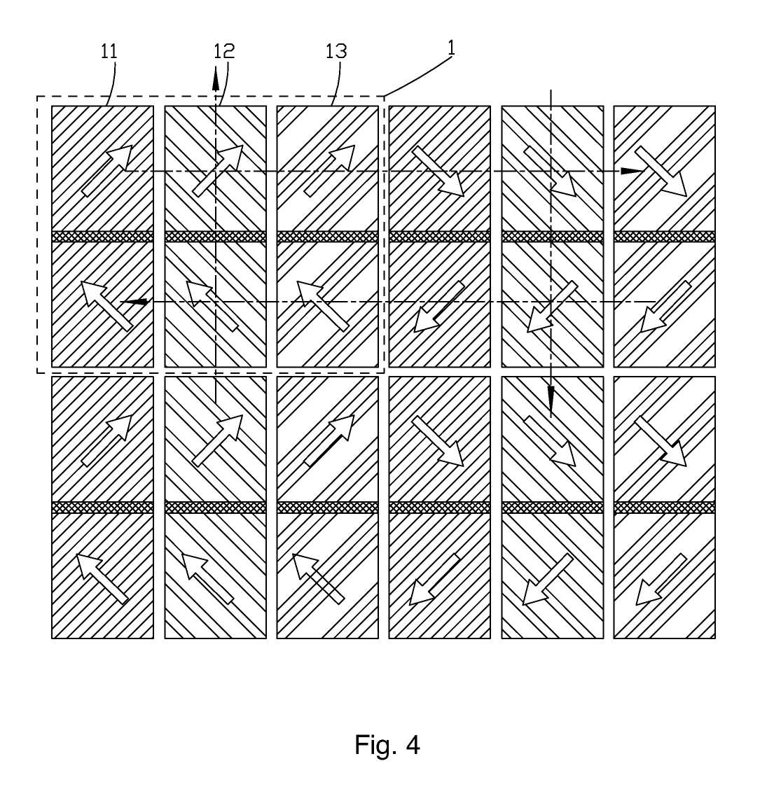

FIG. 4 is a diagram of a UV²A pixel structure according to the second embodiment of the present invention. In the second embodiment, the red sub pixel 11, the green sub pixel 12 and the blue sub pixel 13 are respectively constructed by two upper, lower alignment sub areas which alignment directions are orthogonal. The dimensions of the two upper, lower alignment sub areas which alignment directions are orthogonal are equal. The included angle of the alignment direction of one alignment sub area and the horizontal direction is 45°. The included angle of the alignment direction of the other alignment sub area and the horizontal direction is −45°. In two left, right adjacent pixel units 1, the alignment directions of the alignment sub areas of the corresponding sub pixels are orthogonal. For instance, in two left, right adjacent pixel units 1, the alignment direction of alignment sub area on the top of the red sub pixel 11 at the left side and the alignment direction of alignment sub area on the top of the red sub pixel 11 at the right side are orthogonal.

Compared with the UV²A pixel structure, which each sub pixel is constructed by four alignment sub areas according to prior art, the amount of the alignment sub areas in each sub pixel in the second embodiment is decreased down to two. The dark fringes at the edge of the two corresponding alignment sub areas can be decreased. Accordingly, the light transmittance can be raised and the process difficulty can be lowered for promoting the production efficiency and saving the manufacture cost. By setting the alignment directions of the two alignment sub areas of the corresponding sub pixels in the two left, right pixel unit 1 to be orthogonal, the left, right view angles can be compensated to ensure the display effect.

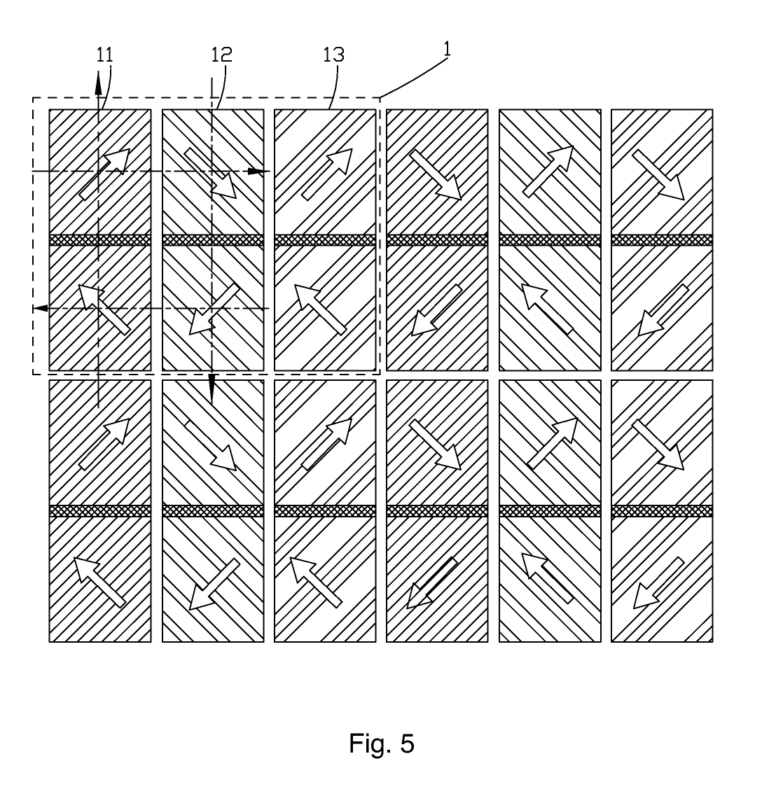

FIG. 5 is a diagram of a UV²A pixel structure according to the third embodiment of the present invention. In the third embodiment, the red sub pixel 11, the green sub pixel 12 and the blue sub pixel 13 are respectively constructed by two upper, lower alignment sub areas which alignment directions are orthogonal. The dimensions of the two upper, lower alignment sub areas which alignment directions are orthogonal are equal. The included angle of the alignment direction of one alignment sub area and the horizontal direction is 45°. The included angle of the alignment direction of the other alignment sub area and the horizontal direction is −45°. In two left, right adjacent sub pixels, the alignment directions of the corresponding alignment sub areas are orthogonal. For instance, in two left, right adjacent red sub pixel 11 and green sub pixel 12, the alignment direction of alignment sub area on the top of the red sub pixel 11 and the alignment direction of alignment sub area on the top of the green sub pixel 12 are orthogonal.

Compared with the UV²A pixel structure, which each sub pixel is constructed by four alignment sub areas according to prior art, the amount of the alignment sub areas in each sub pixel in the third embodiment is decreased down to two. The dark fringes at the edge of the two corresponding alignment sub areas can be decreased. Accordingly, the light transmittance can be raised and the process difficulty can be lowered for promoting the production efficiency and saving the manufacture cost. By setting the alignment directions of the corresponding alignment sub areas in the two left, right sub pixels to be orthogonal, the left, right view angles can be compensated to ensure the display effect.

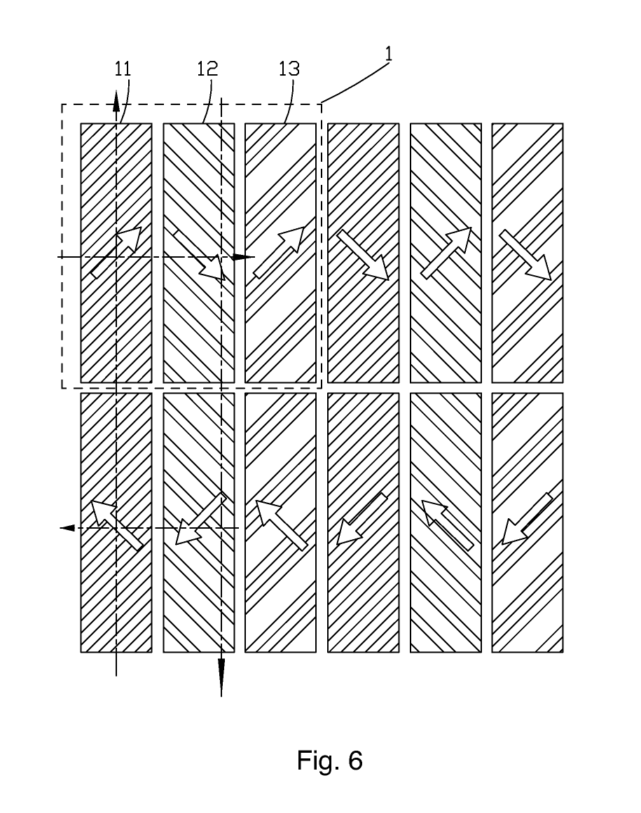

FIG. 6 is a diagram of a UV²A pixel structure according to the fourth embodiment of the present invention. In the fourth embodiment, the red sub pixel 11, the green sub pixel 12 and the blue sub pixel 13 are respectively constructed by one single alignment sub area. The included angle of the alignment direction of the single alignment sub area and the horizontal direction is 45° or −45°. The alignment directions of the alignment sub areas of two upper, lower adjacent sub pixels and two left, right adjacent sub pixels are orthogonal.

Compared with the UV²A pixel structure, which each sub pixel is constructed by four alignment sub areas according to prior art, the amount of the alignment sub areas in each sub pixel in the fourth embodiment is decreased down to one. No dark fringes exist due to the edge of the two corresponding alignment sub areas. Accordingly, the light transmittance can be raised and the process difficulty can be lowered for promoting the production efficiency and saving the manufacture cost. By setting the alignment directions of the alignment sub areas in the upper, lower sub pixels and the two left, right sub pixels to be orthogonal, the view angles can be compensated to ensure the display effect.

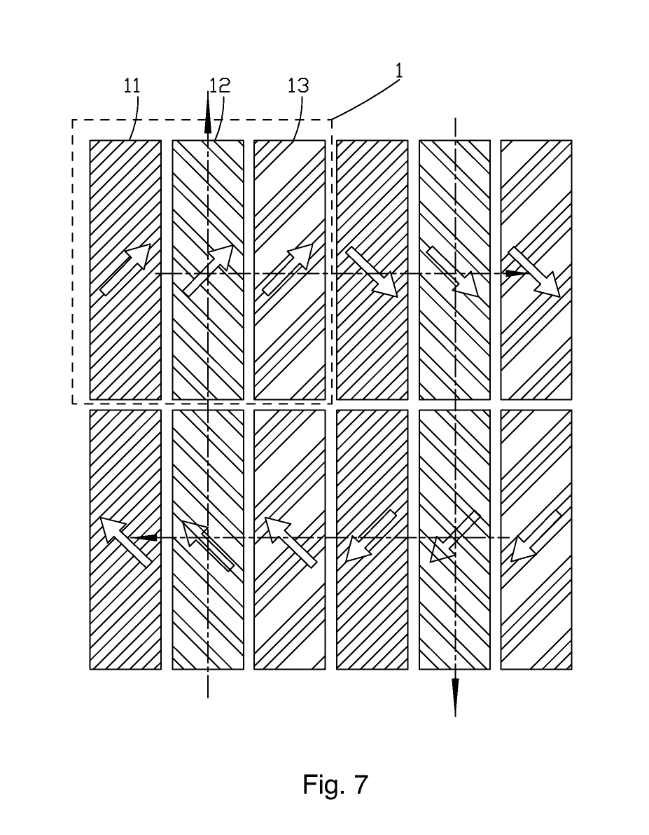

FIG. 7 is a diagram of a UV²A pixel structure according to the fifth embodiment of the present invention. In the fifth embodiment, the red sub pixel 11, the green sub pixel 12 and the blue sub pixel 13 are respectively constructed by one single alignment sub area. The included angle of the alignment direction of the single alignment sub area and the horizontal direction is 45° or −45°. The alignment directions of the alignment sub areas of the corresponding sub pixels in two upper, lower adjacent pixel units 1 and two left, right adjacent pixel units 1 are orthogonal.

Compared with the UV²A pixel structure constructed by four alignment sub areas according to prior art, the amount of the alignment sub areas in each sub pixel in the fifth embodiment is decreased down to one. No dark fringes exist due to the edge of the two corresponding alignment sub areas. Accordingly, the light transmittance can be raised and the process difficulty can be lowered for promoting the production efficiency and saving the manufacture cost. By setting the alignment directions of the alignment sub areas of the corresponding sub pixels in two upper, lower pixel units 1 and two left, right pixel units 1 to be orthogonal, the view angles can be compensated to ensure the display effect.

Significantly, the UV²A pixel structure of the present invention and the UV²A pixel structure, which each sub pixel is constructed by four alignment sub areas according to prior art, have the same display effect from the view angle in the right front. Meanwhile, under wide view angle, the color shift is compensated between the adjacent sub pixels or between the adjacent pixel units. Despite that the resolution descend issue exists in the UV²A pixel structure of the present invention, the watch result is affected slightly by the resolution descend under wide view angle as regarding of the high-resolution liquid crystal panel.

In conclusion, in the UV²A pixel structure of the present invention, the respective sub pixels in each pixel unit are constructed by one single alignment sub area or two alignment sub areas, which can diminish the dark fringes at edge of the alignment sub areas in each sub pixel. By setting the alignment directions of the corresponding alignment sub areas in two adjacent sub pixels to be orthogonal, or the alignment directions of the alignment sub areas of the corresponding sub pixels in two adjacent pixel units to be orthogonal for the view angle compensation to raise the light transmittance and to lower the process difficulty for promoting the production efficiency and saving the manufacture cost.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A UV²A pixel structure, comprising a plurality of pixel units arranged in an array, wherein each pixel unit comprises three parallel arranged sub pixels, which sequentially are a red sub pixel, a green sub pixel and a blue sub pixel, and the red sub pixel, the green sub pixel and the blue sub pixel are respectively constructed by one single alignment sub area or two alignment sub areas which alignment directions are orthogonal; in two adjacent sub pixels, alignment directions of corresponding alignment sub areas are orthogonal, or in two adjacent pixel units, alignment directions of alignment sub areas of corresponding sub pixels are orthogonal.

2. The UV²A pixel structure according to claim 1, wherein the red sub pixel, the green sub pixel and the blue sub pixel are respectively constructed by two left, right alignment sub areas which alignment directions are orthogonal, and in two upper, lower adjacent pixel units, alignment directions of alignment sub areas of corresponding sub pixels are orthogonal.

3. The UV²A pixel structure according to claim 1, wherein the red sub pixel, the green sub pixel and the blue sub pixel are respectively constructed by two upper, lower alignment sub areas which alignment directions are orthogonal, and in two left, right adjacent pixel units, alignment directions of alignment sub areas of corresponding sub pixels are orthogonal.

4. The UV²A pixel structure according to claim 1, wherein the red sub pixel, the green sub pixel and the blue sub pixel are respectively constructed by two upper, lower alignment sub areas which alignment directions are orthogonal, and in two left, right adjacent sub pixels, alignment directions of corresponding alignment sub areas are orthogonal.

5. The UV²A pixel structure according to claim 1, wherein the red sub pixel, the green sub pixel and the blue sub pixel are respectively constructed by one single alignment sub area, and alignment directions of alignment sub areas of two upper, lower adjacent sub pixels and two left, right adjacent sub pixels are orthogonal.

6. The UV²A pixel structure according to claim 1, wherein the red sub pixel, the green sub pixel and the blue sub pixel are respectively constructed by one single alignment sub area, and in two upper, lower adjacent pixel units and two left, right adjacent pixel units, alignment directions of alignment sub areas of corresponding sub pixels are orthogonal.

7. The UV²A pixel structure according to claim 1, wherein in one sub pixel, dimensions of the alignment sub areas which alignment directions are orthogonal are equal.

8. The UV²A pixel structure according to claim 1, wherein included angles between the alignment directions and the horizontal direction are 45° or −45°.

9. A UV²A pixel structure, comprising a plurality of pixel units arranged in an array, and each pixel unit comprises three parallel arranged sub pixels, which sequentially are a red sub pixel, a green sub pixel and a blue sub pixel, and the red sub pixel, the green sub pixel and the blue sub pixel are respectively constructed by one single alignment sub area or two alignment sub areas which alignment directions are orthogonal; in two adjacent sub pixels, alignment directions of corresponding alignment sub areas are orthogonal, or in two adjacent pixel units, alignment directions of alignment sub areas of corresponding sub pixels are orthogonal;
wherein the red sub pixel, the green sub pixel and the blue sub pixel are respectively constructed by two left, right alignment sub areas which alignment directions are orthogonal, and in two upper, lower adjacent pixel units, alignment directions of alignment sub areas of corresponding sub pixels are orthogonal;
wherein in one sub pixel, dimensions of the alignment sub areas which alignment directions are orthogonal are equal;
wherein included angles between the alignment directions and the horizontal direction are 45° or −45°.
